(19) United States
(12) Patent Application Publication
(10) Pub. No.: US 2022/0339876 A1
(43) Pub. Date: Oct. 27, 2022

(54) MAPS INCLUDING ADJUSTMENT VALUES FOR THREE-DIMENSIONAL OBJECTS

(71) Applicant: HEWLETT-PACKARD DEVELOPMENT COMPANY, L.P., Spring, TX (US)

(72) Inventors: Ismael Fernandez Aymerich, Sant Cugat del Valles (ES); Cristina Dominguez Manchado, Sant Cugat del Valles (ES); Roger Fadurdo Orellana, Sant Cugat del Valles (ES); Manuel Freire Garcia, Sant Cugat del Valles (ES)

(21) Appl. No.: 17/238,358

(22) Filed: Apr. 23, 2021

(51) Int. Cl. B29C 64/386; B33Y 50/00; G05B 19/4099

(52) U.S. Cl. CPC B29C 64/386; B33Y 50/00; G05B 19/4099; G06F 30/10

(57) ABSTRACT

In some examples, a system receives information that represents a value of a physical property of a three-dimensional (3D) object as a function of a location of the 3D object built by an additive manufacturing machine. The system generates, based on the received information, a map that includes adjustment values corresponding to different locations of a layer of build material, the adjustment values when applied by the additive manufacturing machine to modify data representing a further 3D object to be built by the additive manufacturing machine.

### BACKGROUND

Additive manufacturing machines produce three-dimensional (3D) objects by building up layers of build material, including a layer-by-layer accumulation and the selective solidification of the build material patterned from computer aided design (CAD) models or other digital representations of physical 3D objects to be formed. A type of an additive manufacturing machine is referred to as a 3D printing system. Each layer of the build material is patterned into a corresponding part (or parts) of the 3D object.

### BRIEF DESCRIPTION OF THE DRAWINGS

Some implementations of the present disclosure are described with respect to the following figures.

FIGS. 1A and 1B illustrate an application of an erosion to a surface of a three-dimensional (3D) object using an offset map according to some examples.

FIG. 2 is a block diagram of an arrangement that includes an additive manufacturing machine and a computer, according to some examples.

FIG. 3 is a flow diagram of a calibration process to generate an offset map, according to some examples.

FIGS. 4A-4C respectively illustrate zones of 3D objects, measured parameter values for the zones of 3D objects, and an offset map, according to some examples.

FIG. 5 is a block diagram of the storage medium storing machine-readable instructions according to some examples.

FIG. 6 is a block diagram of a system according to some examples.

FIG. 7 is a flow diagram of a process of an additive manufacturing machine, according to some examples.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

In the present disclosure, use of the term “a,” “an,” or “the” is intended to include the plural forms as well, unless the context clearly indicates otherwise. Also, the term “includes,” “including,” “comprises,” “comprising,” “have,” or “having” when used in this disclosure specifies the presence of the stated elements, but do not preclude the presence or addition of other elements.

In some examples, a build material used by an additive manufacturing machine such as a 3D printing system can include a powdered build material that is composed of particles in the form of fine powder or granules. The powdered build material can include plastic particles, polymer particles, ceramic particles, glass particles, or particles of other powder-like materials.

As part of the processing of each layer of build material, liquid agents can be dispensed by liquid agent dispensers (such as through a printhead or another fluid dispensing device) onto the layer of build material. In some examples, the applied liquid agents can include a fusing agent (which is a form of an energy absorbing agent including, for example, carbon black particles) that absorbs heat energy emitted from an energy source used in the additive manufacturing process. For example, after a build material layer is deposited onto a build platform (or onto a previously formed build material layer) in the additive manufacturing machine, a fusing agent with a target pattern can be deposited onto portions of the build material layer, to assist in melting of the build material layer portions.

The target pattern can be based on an object model (or more generally, a digital representation) of the physical 3D object that is to be built by the additive manufacturing machine. The portions of the build material layer onto which the fusing agent is deposited will be heated to a higher temperature than other portions of the build material layer without the fusing agent. Heat energy is applied to heat up the build material layer portions for melting. The melted build material layer portions then coalesce and solidify upon cooling.

Another liquid agent that can be applied to a build material layer is a detailing agent, which does not absorb heat energy emitted from the energy source. In some examples, the detailing agent can be applied to an edge boundary portion of the areas in which the fusing agent is deposited, to provide a cooling effect at the edge boundary portion. The presence of the detailing agent combats the effect of coalescence bleed caused by fusing due to heating in adjacent portions of the build material layer. The detailing agent can thus help in defining more accurate boundary portions of a 3D object.

In some examples, an additive manufacturing machine can be used to build 3D objects with small features. A small feature can refer to a part of a 3D object that has a dimension (e.g., diameter, width, length, height, etc.) less than a specified threshold, such as less than 250 micrometers (μm), or less than 500 μm, or less than 1 millimeter (mm), or less than 2 mm, and so forth.

A mechanical property of a small feature can be sensitive to thermal effects across a 3D object as the 3D object is being built on a layer-by-layer basis by an additive manufacturing machine. Thermal effects in multiple different directions (e.g., along the X, Y, and Z axes) can be caused by heat conduction resulting from differences in temperature across the 3D object. As used here, the X and Y axes define a horizontal plane of a build material layer. The Z axis is a vertical axis that is perpendicular to the horizontal plane, and extends through multiple build material layers. Although reference is made to “horizontal” and “vertical,” it is noted that a plane of a build material layer may have a different direction depending upon the orientation of a build platform of an additive manufacturing machine.

A “thermal variation” at a given location of the 3D object can refer to a change in temperature at the given location as compared to the expected temperature at the given location. For example, the given location can be a location where a liquid agent (e.g., a fusing agent or detailing agent) is applied, or where a liquid agent is not applied. A “location” of the 3D object can refer to a specific sub-area or sub-volume of the 3D object.

An example of a mechanical property of a feature of a 3D object that can be sensitive to thermal variations is a stiffness of the 3D object. Stiffness can refer to the extent to which an object resists deformation in response to an applied force. The stiffness of a feature is a measure of the resistance offered by the feature to deformation, and stiffness is derived based on an amount of displacement produced by a force applied on the feature.

In other examples, other mechanical properties of features of 3D objects can vary as a function of thermal variations. Examples of such other mechanical properties can include elasticity, strength, hardness, and so forth. In further examples, other physical properties of 3D objects can vary as a function of thermal effects, such as color, density, electrical conductivity, thermal conductivity, a chemical property, and so forth.

As used here, a “physical property” of a feature (e.g., a small feature or feature of a larger size) of a 3D object built by an additive manufacturing machine can refer to any of the foregoing properties or other properties that may be affected by thermal variations.

In some cases, a thermal variation at a given location of a 3D object can result in the given location having a higher temperature than expected, which can cause a feature of the 3D object at the given location to exhibit increased local growth (referred to as “blooming”) in which more growth occurs at a surface of the feature than would have occurred at a lower temperature. A 3D object can have an outer surface (more simply referred to as “surface” in the ensuing discussion). The surface of the 3D object is formed of a stack of layers of build material, where a stack of layers can include a single layer or multiple layers. This stack of layers has a thickness, which is referred to as a “surface thickness.”

A blooming effect at the feature of the 3D object can cause the feature to have a greater surface thickness than expected. The greater surface thickness can be caused by the higher temperature causing melting of a greater amount of build material that results in subsequent coalescence when cooled.

In other cases, a thermal variation at a given location of a 3D object can result in the given location having a lower temperature than expected, which can cause a feature at the given location to exhibit reduced local growth (referred to as “erosion”) in which less growth occurs at the feature than would have occurred at a higher temperature. Erosion can cause the feature to have a reduced surface thickness than expected.

In either case, the change in amount of local growth at a feature of a 3D object can cause a number of physical properties (e.g., any or some combination of the physical properties noted further above) to vary from a target range of values. As used here, a “number” can refer to one or greater than one.

In addition to a thermal variation across a 3D object in a number of different dimensions, there can be thermal variation across a build bed of an additive manufacturing machine. A “build bed” can refer to the upper surface of a build platform (in the additive manufacturing machine) on which a 3D object is to be built. A “build bed” can also refer to the upper surface of previously formed build material layer(s). Depending upon the size of the 3D object being built by the additive manufacturing machine, multiple 3D objects can be built across a build bed. Thermal variations across the build bed can cause 3D objects in different locations of the build bed to experience different temperatures and consequently have different physical properties.

In accordance with some implementations of the present disclosure, an offset map can be generated for application by an additive manufacturing machine to apply in a build operation of a 3D object to compensate for variations in the number of physical properties of the 3D object due to thermal variations at different locations. The offset map includes adjustment values that are applied during processing of a layer of build material during the build operation to cause erosion or growth of surfaces of the 3D object as the 3D object is being built.

A “map” can refer to any data structure containing values as a function of a variable, where in some examples the variable can be a location across a build bed and/or across a 3D object. For example, the map can be in the form of an array of values, a table with multiple entries, a function that produces an output value in response to an input value, and so forth.

Erosion of a surface of a 3D object refers to removing voxels (or more specifically, removing “black” voxels) from data representing the surface such that a surface thickness of the 3D object is reduced as compared to a target surface thickness of the 3D object as represented by a digital representation of the 3D object. A “black” voxel is a voxel that is intended to be part of the to be generated 3D object. Removing a black voxel refers to eliminating the voxel from being part of the 3D object. The digital representation of the 3D object can be in to form of a computer aided design (CAD) model that defines portions of the 3D object. The CAD model can have any or some combination of the following formats: a STereoLithographic (STL) file, an OBJ file, a Drawing Exchange Format (DXF) file, a JavaScript Object Notation (JSON) file, a 3D Manufacturing Format (3MF) file, a Visualization Toolkit (VTK) file, or the like.

The data representing the surface on which the erosion is applied is part of the digital representation of the 3D object. The surface of the 3D object has a stack of layers, and the data represents the stack of layers. Each layer of the stack of layers is represented by a layer of voxels (or multiple layers of voxels). Removing voxels from the data can refer to removing layer(s) of voxels or removing a portion of the layer(s) of voxels that represent the surface of the 3D object.

Growth of the surface of the 3D object refers to adding “black” voxels (e.g., layer(s) of voxels or a portion thereof) to the data representing the surface such that a surface thickness of the 3D object is increased as compared to the target surface thickness of the 3D object as represented by the digital representation of the 3D object.

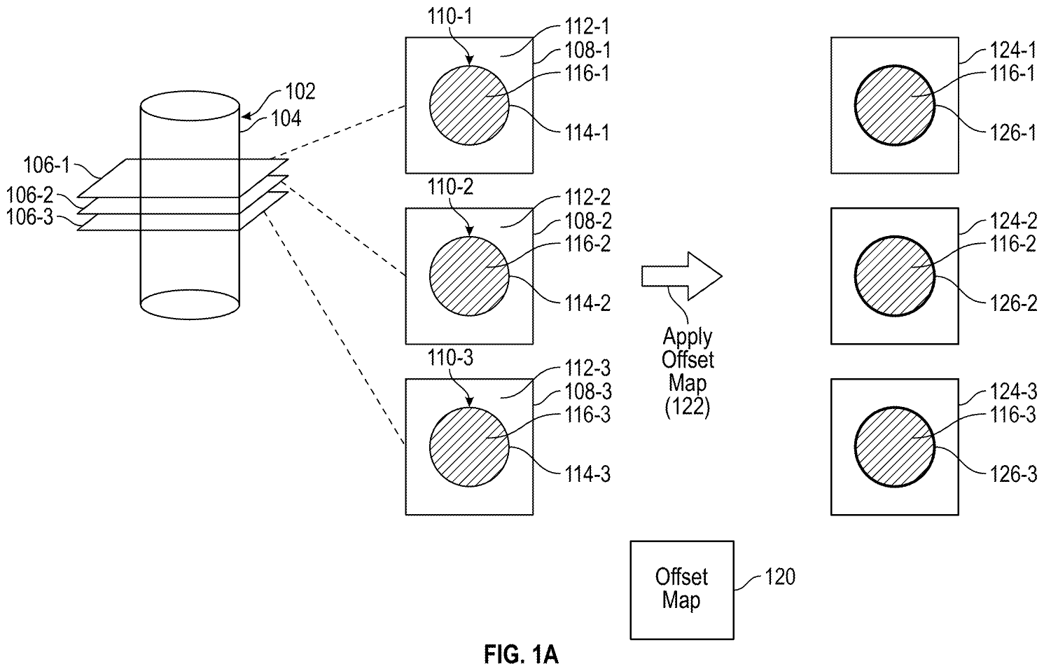

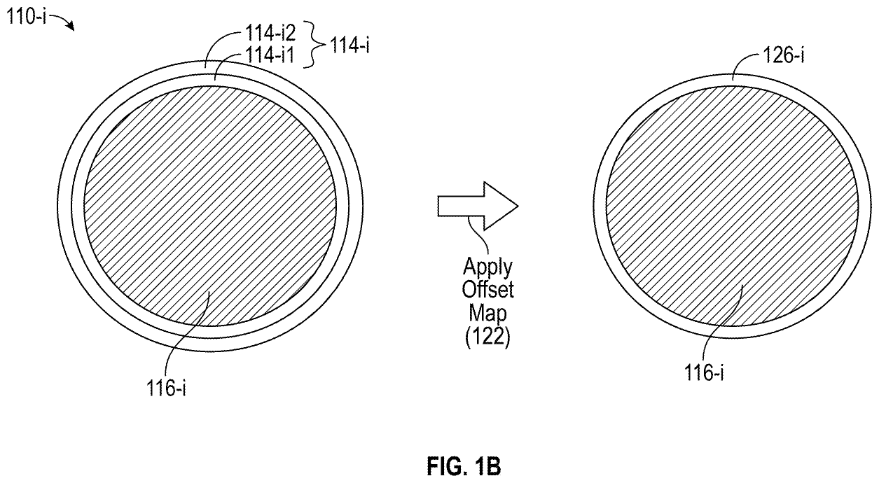

FIGS. 1A and 1B illustrate an example of applying erosion to a surface of a 3D object. In an example, a digital representation 102 of a 3D object represents a cylinder. This cylinder can be part of a larger 3D object. For example, the cylinder can be a small feature that is part of a larger 3D object. In other examples, digital representations can represent more complex 3D objects, such as 3D objects with bores or openings or 3D objects with features of irregular shapes.

The cylinder has a side surface 104, which is part of the outer surface of the cylinder. Due to thermal variations, a surface thickness of the surface 104 of the cylinder may vary from an expected surface thickness. As a result, a physical property, such as a stiffness, of the cylinder may vary from an expected value when the cylinder is built by an additive manufacturing machine.

The additive manufacturing machine receives the digital representation 102 of the cylinder. The additive manufacturing machine generates, based on the digital representation 102, slices 106-1, 106-2, and 106-3 of the cylinder to produce respective slice data 108-1, 108-2, and 108-3. Each slice data 108-1, 108-2, or 108-3 may define a respective portion of the cylinder that is to be formed from a corresponding build material layer, based on solidifying or coalescing parts of the build material layer by applying a liquid agent. In other examples, the slicing of the digital representation 102 to produce slice data can be performed by a computer external of the additive manufacturing machine. In such latter examples, the slice data is sent by the computer to the additive manufacturing machine.

Although three slices 106-1, 106-2, and 106-3 are shown in FIG. 1A, it is noted that there can be a different quantity of slices generated by the additive manufacturing machine.

Each slice data 108-i (i=1 to 3) includes a respective first slice data region 110-i that defines a respective portion within the cylinder. Each slice data 108-i further includes a respective second slice data region 112-i that defines a respective portion outside the cylinder.

An outer circumferential sub-region 114-1, 114-2, or 114-3 of the corresponding slice data region 110-1, 110-2, or 110-3 defines the outer surface 104 of the cylinder.

FIG. 1B illustrates an enlarged view of the slice data region 110-i. The slice data region 110-i includes an inner core sub-region 116-i that defines the inner core of the cylinder, and the outer circumferential sub-region 114-i that defines a respective part of the outer surface 104 of the cylinder. Note that the outer surface 104 of the cylinder, as represented by the outer circumferential sub-region 114-i of the digital representation 102 of the cylinder, includes a stack of layers of voxels, including a first layer 114-i1 of voxels and a second layer 114-i2 of voxels. Note that in other examples a stack of layers representing an outer circumferential sub-region can have one layer or more than two layers. The layers 114-i1 and 114-i2 of voxels define a surface thickness of the respective part of the outer surface 104 of the cylinder. In the example shown in FIG. 1B, the surface thickness of the outer surface 104 of the cylinder is the thickness of the two layers of voxels. More generally, an outer circumferential sub-region can have a different arrangement of layers of voxels that defines an outer surface thickness.

In accordance with some implementations of the present disclosure, an offset map may 120 can be provided to or generated by the additive manufacturing machine, where the offset map 120 contains adjustment values to compensate for thermal variations that may result in a number of physical properties of the cylinder deviating from expected range(s) of values. The generation of the offset map 120 is discussed further below.

The additive manufacturing machine applies (at 122) the offset map 120 to the slice data 108-1, 108-2, and 108-3, to produce respective modified slice data 124-1, 124-2, and 124-3. Each modified slice data 124-i includes a respective outer circumferential sub-region 126-i that has been modified from the outer circumferential sub-region 114-i. In the enlarged view shown in FIG. 1B, the modified outer circumferential sub-region 126-i includes one layer of voxels, as compared to the two layers of voxels of the outer circumferential sub-region 114-i prior to the modification based on application of the offset map 120. Thus, in the example shown in FIG. 1B, erosion has been applied to the outer circumferential sub-region 114-i to remove one of the layers of voxels.

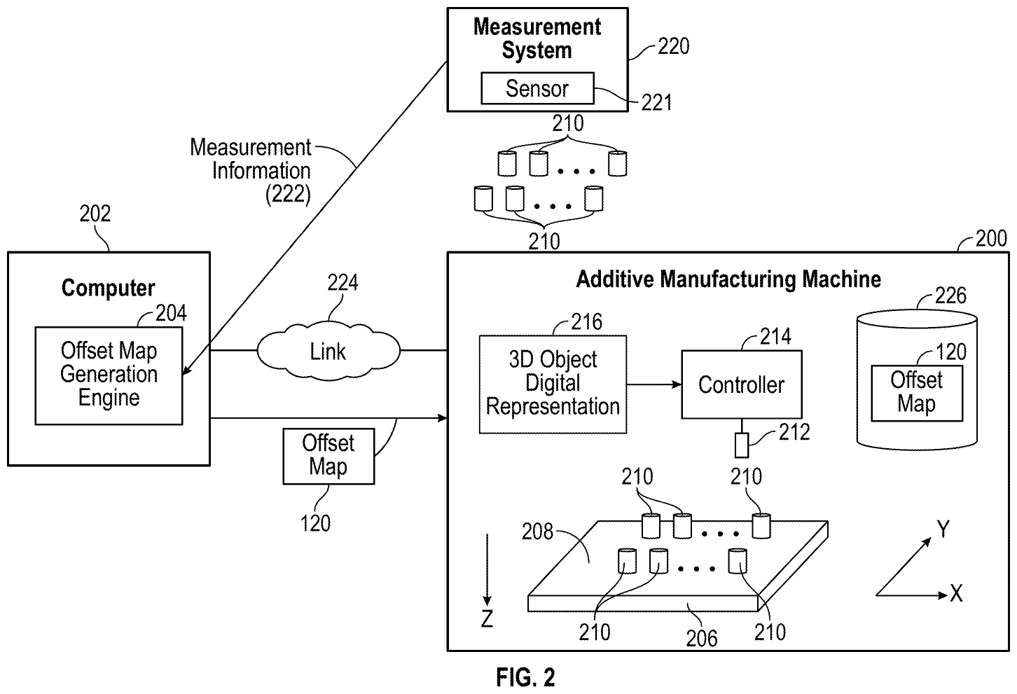

FIG. 2 is a block diagram of an arrangement that includes an additive manufacturing machine 200, such as a 3D printing system, and a computer 202. The computer 202 includes an offset map generation engine 204 that produces the offset map 120 according to some implementations of the present disclosure.

As used here, an “engine” can refer to a hardware processing circuit, which can include any or some combination of a microprocessor, a core of a multi-core microprocessor, a microcontroller, a programmable integrated circuit, a programmable gate array, or another hardware processing circuit. Alternatively, an “engine” can refer to a combination of a hardware processing circuit and machine-readable instructions (software and/or firmware) executable on the hardware processing circuit.

Although FIG. 2 shows the offset map generation engine 204 as being part of the computer 202 that is separate from the additive manufacturing machine 200, in other examples, the offset map generation engine 204 can be part of the additive manufacturing machine 200. In such latter examples, the offset map generation engine 204 can be part of a controller 214 of the additive manufacturing machine 200, or can be separate from the controller 214. As used here, a “controller” can refer to a hardware processing circuit, or a combination of a hardware processing circuit and machine-readable instructions, that controls various operations (including build operations) of the additive manufacturing machine 200.

The additive manufacturing machine 200 includes a build platform 206 on which 3D objects 210 are to be formed by the additive manufacturing machine 200 on a layer-by-layer basis (i.e. successive layers of build material are added and processed based on application of liquid agent(s) and heat). In accordance with some examples of the present disclosure, the 3D objects 210 built by the additive manufacturing machine 200 can include multiple instances (copies) of a particular 3D object. The multiple instances of the particular 3D object are formed across different locations of the build platform 206. For example, a collection of the multiple instances of the particular 3D object can be formed generally across a horizontal plane along the X and Y axes.

The build platform 206 has an upper surface 208 on which successive layers of powdered build material are spread, and then processed to form respective layers of the 3D objects 210. During the build operation, the build platform 206 is incrementally lowered in a direction that is generally parallel to the Z axis, which in the example of FIG. 2 is a vertical axis. Thus, in the example of FIG. 2, the build platform 206 is moveable upwardly and downwardly. During a build operation in which successive layers of powdered build material are spread, the build platform 206 is incrementally moved downwardly by a specified distance corresponding to the build material layer thickness, for example, 20, 40, 50, 70 or 90 microns. With each incremental lowering of the build platform 206, another subsequent layer of build material is applied over the build platform 206 for processing.

Although not shown in FIG. 2, the additive manufacturing machine 200 also includes a spreader to spread each layer of build material across the build platform 206. The spreader can be in the form of a blade, a roller, or any other structure that is able to spread a layer of powdered build material across a build bed.

A fluid dispensing device 212 (e.g., a printhead) can be mounted to a moveable carriage (not shown) in the additive manufacturing machine 200. During a build operation, the carriage can move back and forth to move the fluid dispensing device 212 along a scan axis (or multiple scan axes), to dispense liquid agents (e.g., fusing agents, detailing agents, etc.) to a layer of build material spread across a build bed (either the upper surface 208 of the build platform 206 or previously processed build material layer(s)).

During a build operation, the controller 214 of the additive manufacturing machine 200 can control the operation of various components, including the build platform 206, the spreader, the fluid dispensing device 212, and so forth.

The collection of 3D objects 210 can be built by the additive manufacturing machine 200 for the purpose of calibrating the additive manufacturing machine 200, such as to calibrate the additive manufacturing machine 200 to compensate for thermal variations across a build bed. The building of the collection of 3D objects 210 can be in response to a request from the offset map generation engine 204 or from a different source, such as a user, a program, a machine, and so forth. As part of the request, a digital representation 216 of a 3D object is provided to the additive manufacturing machine 200. For example, the digital representation 216 can include the digital representation 102 of the cylinder shown in FIG. 1A.

To calibrate the additive manufacturing machine 200, the multiple instances of the particular 3D object are characterized for the purpose of determining whether thermal variations across the build bed may cause a number of physical properties of the particular 3D object to vary from expected range(s) of values. For example, the particular 3D object can include small features with a stiffness that may be sensitive to thermal variations across the build bed.

The calibration of the additive manufacturing machine 200 can be performed when a user first receives the additive manufacturing machine 200 from a manufacturer or other vendor. Additionally or alternatively, the user can trigger the calibration periodically or in response to other events, such as upon detecting that 3D objects built by the additive manufacturing machine 200 are not uniform and/or exhibit defects.

Once the collection of 3D objects 210 is built by the additive manufacturing machine 200 as part of a calibration operation, the collection of 3D objects 210 can be moved to a location where a measurement system 220 can be used to measure a number of properties of the collection of 3D objects 210. In the example of FIG. 2, the measurement system 220 includes a sensor 221 (or multiple sensors) to measure the number of properties of the collection of 3D objects 210. For example, a physical property of each of the 3D objects in the collection of 3D objects 210 that can be measured can include a parameter that represents a stiffness of the 3D object.

Stiffness is expressed as force (applied on a feature of the 3D object) divided by a displacement of the feature in response to the force. In some cases, the parameter that is measured can be the force applied to cause displacement of the feature of the 3D object by some specified amount. Thus, the measured force is representative of the stiffness. In other examples, the force applied and the displacement caused by the applied force can be measured to calculate the stiffness.

The measurement system 220 can send measurement information 222 (which represents values of the number of physical properties of the collection of 3D objects 210) to the computer 202. As part of the calibration operation, the offset map generation engine 204 uses the measurement information 222 to generate the offset map 120 that includes adjustment values. The adjustment values in the offset map correspond to different locations in a plane, where the adjustment values when applied by the additive manufacturing machine 200 is to adjust data representing a surface of a 3D object. For example, the data representing the surface of the 3D object can include the outer circumferential sub-region 114-i of the slice data region 110-i shown in FIGS. 1A and 1B.

In some examples, the offset map 120 can be applied to modify multiple slice data. In other examples, different offset maps can be applied to modify different slice data.

The offset map 120 can be sent over a communication link 224 from the computer 202 to the additive manufacturing machine 200 as part of the calibration operation. The communication link 224 can include a wired link or a wireless link.

The controller 214 can store the received offset map 120 in a repository 226. The repository 226 can be implemented using a number of storage devices, such as disk-based storage devices, solid state storage devices, and so forth. The offset map 120 can be used by the controller 214 during a build operation to modify slice data derived from the digital representation 216, where the modified slice data is used to build a 3D object.

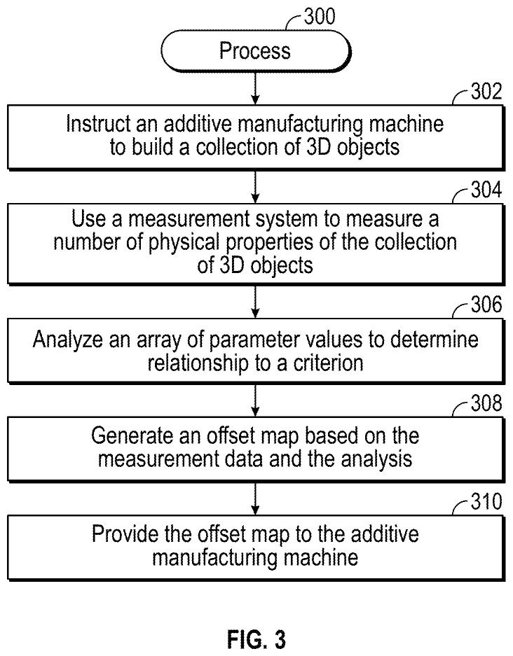

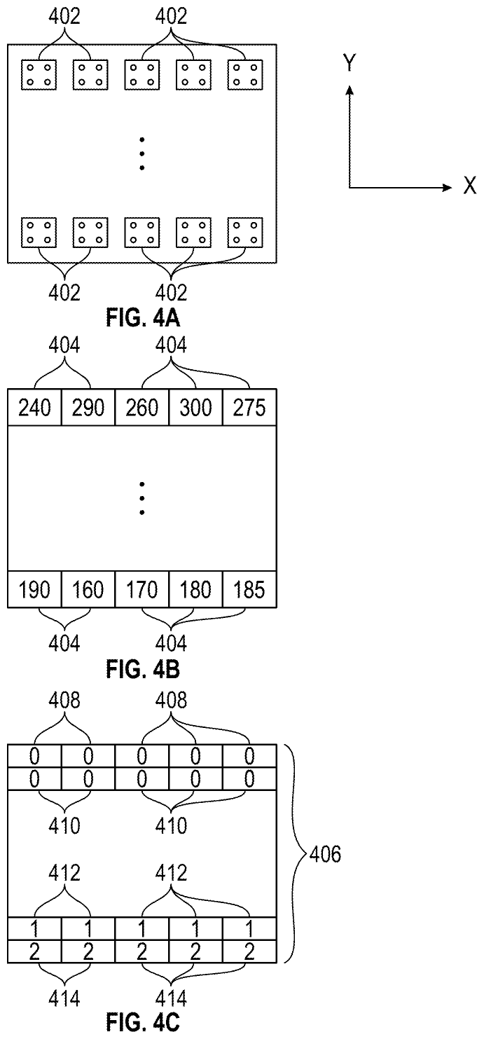

The following discussion refers to FIGS. 3 and 4A-4C. FIG. 3 is a flow diagram of a process 300 of producing an offset map (e.g., 120 in FIG. 1A or 2) in an additive manufacturing machine calibration operation according to some examples. The additive manufacturing machine is instructed (at 302) to build a collection of 3D objects (e.g., 210 in FIG. 2). The collection of 3D objects may be formed in multiple zones 402 as shown in FIG. 4A. In some examples, the collection of 3D objects that are built are multiple instances of the same 3D object. The zones 302 are arranged in a plane along the X and Y axes. The additive manufacturing machine can build multiple 3D objects (each 3D object represented by a small circle in FIG. 4A) within each zone 402. In other examples, just a single 3D object can be formed in each zone 402. More generally, if a 3D object is large, then just a single 3D object is built by the additive manufacturing machine for the calibration operation.

As discussed above in connection with FIG. 2, the measurement system 220 is used (at 304) to measure a number of physical properties of the collection of 3D objects built in the zones 402. The measurement information of the number of physical properties includes values of a number of parameters representing the number of physical properties. For example, assuming a stiffness of features of the 3D objects in the zones 402 is measured by the measurement system 220, FIG. 4B shows an array of parameter values 404 representing the measured stiffness of the features of the 3D objects. Each parameter value 404 in the array can represent an average (or other mathematical aggregate such as median, sum, maximum, minimum, etc.) of measured stiffness values in the respective zone 402. For example, if there are N (N>1) 3D objects built in each zone 402, then each stiffness value 404 can be the average of the stiffness values of the N 3D objects in the zone 402.

The array of parameter values 404 can be analyzed (at 306), such as by the offset map generation engine 204 or a human user, to determine a relationship of the parameter values 404 to a criterion. The analysis includes determining which parameter values 404 satisfy a criterion, and which other parameter values 404 violate the criterion. For example, the criterion may specify that a value of a measured parameter is to be within a specified range, such as less than a threshold, greater than a threshold, or between first and second thresholds. In such examples, a parameter value 404 satisfies the criterion if the parameter value 404 is within the specified range, and the parameter value 404 violates the criterion if the parameter value 404 is outside the specified range.

For example, if the criterion specifies that a parameter representing a target stiffness of a feature of a 3D object is between 200 and 350 grams-force (a gram-force is a unit of force equal to a mass of one gram multiplied by the standard acceleration due to gravity), then the parameter values 404 in the first row of the array of values 404 in FIG. 4B satisfy the criterion, while the parameter values 404 in the last row of the array of values 404 violate the criterion. The stiffness is represented by the force employed to displace a feature by a specified displacement. This force can be measured using a force gauge, for example.

In some examples, adjustment does not have to be performed for a zone 402 associated with a parameter value that satisfies the criterion. However, if the parameter value for a particular zone 402 violates the criterion, then adjustment is to be performed for 3D objects in the particular zone 402.

Based on the measurement information (e.g., the array of parameter values 404) and the analysis (306), the offset map generation engine 204 generates (at 308) an offset map 406 (FIG. 4C) that contains adjustment values. In the example of FIG. 4C, an adjustment value of 0 indicates that no adjustment is performed when building a 3D object in a corresponding sub-zone, an adjustment value of 1 indicates that a surface thickness is to be increased by one layer of voxels when building a 3D object in a corresponding sub-zone, and an adjustment value of 2 indicates that a surface thickness is to be increased by two layers of voxels when building a 3D object in a corresponding sub-zone.

The addition of layer(s) of voxels to the surface thickness of a 3D object causes growth of the surface. In other examples, the adjustment values can cause removal of layer(s) of voxels to a surface thickness of a 3D object. For example, a positive adjustment value can refer to adding layer(s) of voxels to a surface thickness of a 3D object, and a negative adjustment value can refer to removing layer(s) of voxels to a surface thickness of a 3D object, or vice versa.

The offset map 406 can include other adjustment values in other examples.

In some examples, the generation of the offset map 406 can be based on correlation information (e.g., included in a lookup table) that correlates parameter values to adjustment values. For example, the correlation information can correlate adjustment parameter values that satisfy a criterion to an adjustment value of 0, and the correlation information can correlate adjustment parameter values that violate a criterion to a number of other adjustment values (a single adjustment value or multiple adjustment values, such as 1 and 2 in FIG. 4B). In other examples, the correlation can include a function that produces an adjustment value in response to an input parameter value. In further examples, the offset map generation engine 204 generates the offset map 406 based on input from a user.

In the offset map 406, an adjustment value of 0 is assigned in sub-zones 408 and 410, which correspond to the first row of the array of parameter values 404 that satisfy the criterion (so that no adjustment has to be performed for 3D objects built in zones 402 corresponding to the first row of the array of parameter values 404). An adjustment value of 1 is assigned in sub-zones 412, and an adjustment value of 2 is assigned in sub-zones 414. The sub-zones 412 and 414 correspond to the last row of the array of parameter values 404 that violate the criterion (so that adjustments are performed for 3D objects built in zones 402 corresponding to the last row of the array of parameter values 404).

For ease of explanation, it is assumed that each zone 402 is divided into two sub-zones. More generally, each zone 402 can be divided into more than two sub-zones, such as an array of sub-zones in the X and Y axes. In other examples, just a single adjustment value is assigned to each zone 402.

The division of each zone 402 into multiple sub-zones reflects the likelihood that thermal variation across the build bed does sharply spike or drop across neighboring locations. The thermal variation across the build bed can be gradual along a given direction (e.g., along the Y axis).

Note also that there can be thermal variation in other directions, such as along the X axis. The adjustment values assigned in the offset map can thus vary across the X axis. It is also possible that there is thermal variation along the Z axis. In this latter scenario, different offset maps can be used for different Z offsets along the Z axis.

The process 300 provides (at 310) the offset map 406 to the additive manufacturing machine for use by the additive manufacturing machine in building a 3D object in subsequent build operations. If the generation of the offset map 406 occurs at a computer (e.g., 202 in FIG. 2) that is separate from the additive manufacturing machine, the offset map 406 is transmitted from the computer to the additive manufacturing machine for storage by the additive manufacturing machine. If the generation of the offset map 406 occurs at the additive manufacturing machine, then the additive manufacturing machine stores the offset map 406 for subsequent use.

Note that different types of 3D objects can be associated with different offset maps. Thus, a first offset map can be used in building a first type of 3D object, a second offset map can be used in building a second type of 3D object, and so forth.

In examples according to FIGS. 4A-4C, it is assumed that the 3D objects built by the additive manufacturing machine are small enough such that multiple 3D objects are built across the build bed. In such examples, any given adjustment value in the offset map 406 is applied to a 3D object or to multiple 3D objects in a respective zone 402.

In other examples, a 3D object can be large such that just a single 3D object or a small quantity of 3D objects is (are) built on the build bed. In such latter examples, an offset map can include adjustment values for different locations of a 3D object.

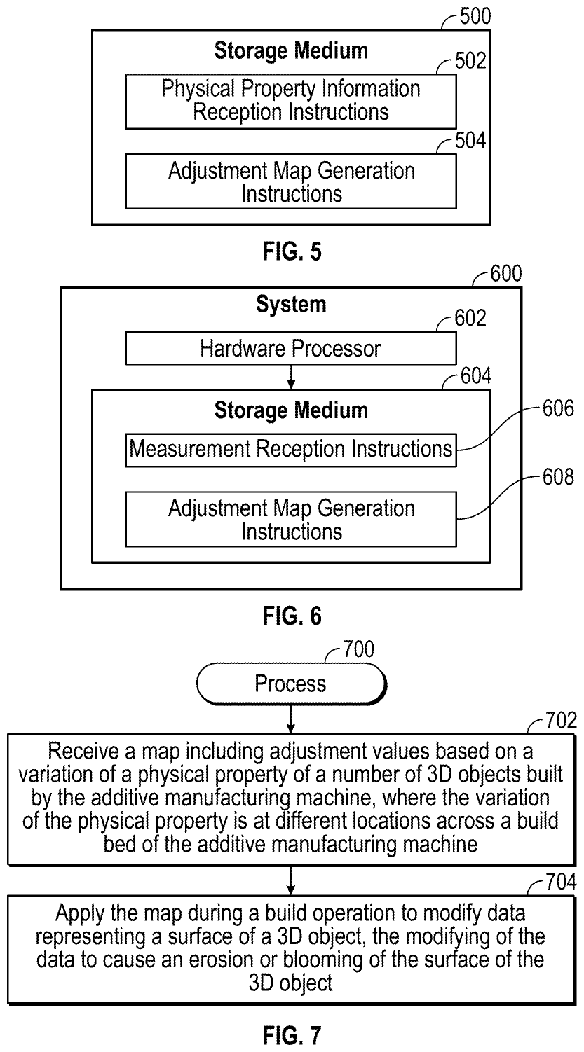

FIG. 5 is a block diagram of a non-transitory machine-readable or computer-readable storage medium 500 storing machine-readable instructions that upon execution cause a system to perform various tasks. The system can include a computer or an additive manufacturing machine.

The machine-readable instructions include physical property information receptions 502 to receive information that represents a value of a physical property of a 3D object as a function of a location of the 3D object built by an additive manufacturing machine.

In some examples, the received information includes measurement information (e.g., 222 in FIG. 2) including values of the physical property acquired for multiple instances of the 3D object at respective different locations across a build bed of the additive manufacturing machine.

The machine-readable instructions include adjustment map generation instructions 504 to generate, based on the received information, a map that includes adjustment values corresponding to different locations of a layer of build material. The adjustment values when applied by the additive manufacturing machine modifies data representing a further 3D object to be built by the additive manufacturing machine.

In some examples, the adjustment values when applied by the additive manufacturing machine are to cause an increase or decrease of a surface thickness of the 3D object. For example, an adjustment value of the map represents a quantity of voxels (e.g., a quantity of layers of voxels) to add to or subtract from data representing a surface of the further 3D object. An adjustment value of the map when applied by the additive manufacturing machine is to cause erosion or growth of a surface of the 3D object.

In some examples, the generation of the map is based on a correlation of values of the physical property to respective adjustment values.

In some examples, the receiving task and the generating task are re-iterated multiple times (e.g., in respective calibration operations) over a life of the additive manufacturing machine.

FIG. 6 is a block diagram of a system 600 including a hardware processor 602 (or multiple hardware processors). A hardware processor can include a microprocessor, a core of a multi-core microprocessor, a microcontroller, a programmable integrated circuit, a programmable gate array, or another hardware processing circuit. The system 600 can be a computer or an additive manufacturing machine.

The system 600 further includes a storage medium 604 that stores machine-readable instructions executable on the hardware processor 602 to perform various tasks. Machine-readable instructions executable on a hardware processor can refer to the instructions executable on a single hardware processor or the instructions executable on multiple hardware processors.

The machine-readable instructions in the storage medium 604 include measurement information reception instructions 606 to receive measurement information that represents values of a physical property of plural instances of a 3D object as a function of location across a build bed of an additive manufacturing machine. A first value of the physical property of a first instance of the 3D object at a first location on the build bed satisfies a criterion, and a second value of the physical property of a second instance of the 3D object at a second location on the build bed violates the criterion.

The machine-readable instructions in the storage medium 604 include adjustment map generation instructions 608 to generate, based on the received measurement information, a map that includes adjustment values corresponding to different locations of a layer of build material. The map when applied by the additive manufacturing machine modify data representing a further 3D object to be built by the additive manufacturing machine.

FIG. 7 is flow diagram of a process 700 according to some examples. The process 700 can be performed by an additive manufacturing machine.

The process 700 includes receiving (at 702) a map including an adjustment values based on a variation of a physical property of a number of 3D objects built by the additive manufacturing machine. The variation of the physical property is at different locations across a build bed of the additive manufacturing machine.

The process 700 includes applying (at 704) the map during a build operation to modify data representing a surface of a 3D object, the modifying of the data to cause an erosion or growth of the surface of the 3D object.

The application of the map during the build operation is on a build material layer-by-layer basis, in which the map is applied when processing an individual layer of build material.

A storage medium (e.g., 500 in FIG. 5 or 604 in FIG. 6) can include any or some combination of the following: a semiconductor memory device such as a dynamic or static random access memory (a DRAM or SRAM), an erasable and programmable read-only memory (EPROM), an electrically erasable and programmable read-only memory (EEPROM) and flash memory or other type of non-volatile memory device; a magnetic disk such as a fixed, floppy and removable disk; another magnetic medium including tape; an optical medium such as a compact disk (CD) or a digital video disk (DVD); or another type of storage device. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A non-transitory machine-readable storage medium comprising instructions that upon execution cause a system to:
receive information that represents a value of a physical property of a three-dimensional (3D) object as a function of a location of the 3D object built by an additive manufacturing machine; and
generate, based on the received information, a map that includes adjustment values corresponding to different locations of a layer of build material, the adjustment values when applied by the additive manufacturing machine to modify data representing a further 3D object to be built by the additive manufacturing machine.

2. The non-transitory machine-readable storage medium of claim 1, wherein the received information comprises measurement information including values of the physical property acquired for multiple instances of the 3D object at respective different locations across a build bed of the additive manufacturing machine.

3. The non-transitory machine-readable storage medium of claim 1, wherein the adjustment values when applied by the additive manufacturing machine are to cause an increase or decrease of a surface thickness of the 3D object.

4. The non-transitory machine-readable storage medium of claim 3, wherein an adjustment value of the adjustment values of the map represents a quantity of voxels to add to or subtract from data representing a surface of the further 3D object.

5. The non-transitory machine-readable storage medium of claim 3, wherein an adjustment value of the adjustment values when applied by the additive manufacturing machine is to cause erosion of a surface of the 3D object.

6. The non-transitory machine-readable storage medium of claim 3, wherein an adjustment value of the adjustment values when applied by the additive manufacturing machine is to cause growth of a surface of the 3D object.

7. The non-transitory machine-readable storage medium of claim 1, wherein the instructions upon execution cause the system to:
send the map to the additive manufacturing machine.

8. The non-transitory machine-readable storage medium of claim 1, wherein the generating of the map is based on a correlation of values of the physical property to respective adjustment values.

9. The non-transitory machine-readable storage medium of claim 1, wherein the receiving and the generating are re-iterated multiple times over a life of the additive manufacturing machine.

10. The non-transitory machine-readable storage medium of claim 1, wherein the receiving and the generating are performed for the further 3D object of a first type, and wherein the instructions that upon execution cause the system to:
receive information that represents a value of a physical property of another 3D object as a function of a location of the another 3D object built by the additive manufacturing machine; and
generate a further map that includes adjustment values corresponding to different locations of a layer of build material, the adjustment values of the further map when applied by the additive manufacturing machine to modify data representing a 3D object according to a different second type to be built by the additive manufacturing machine.

11. The non-transitory machine-readable storage medium of claim 1, wherein the physical property of the 3D object represents a stiffness of the 3D object.

12. A system comprising:
a processor; and
a non-transitory storage medium storing instructions executable on the processor to:
receive measurement information that represents values of a physical property of plural instances of a three-dimensional (3D) object as a function of location across a build bed of an additive manufacturing machine, wherein a first value of the physical property of a first instance of the 3D object at a first location on the build bed satisfies a criterion, and a second value of the physical property of a second instance of the 3D object at a second location on the build bed violates the criterion; and
generate, based on the received measurement information, a map that includes adjustment values corresponding to different locations of a layer of build material, the map when applied by the additive manufacturing machine to modify data representing a further 3D object to be built by the additive manufacturing machine

13. The system of claim 12, wherein the instructions are executable on the processor to:
initiate, as part of a calibration operation of the additive manufacturing machine, a 3D build operation by the additive manufacturing machine to build the plural instances of the 3D object across the build bed.

14. A method of an additive manufacturing machine, comprising:
receiving a map comprising an adjustment values based on a variation of a physical property of a number of three-dimensional (3D) objects built by the additive manufacturing machine, the variation of the physical property being at different locations across a build bed of the additive manufacturing machine; and
applying the map during a build operation to modify data representing a surface of a 3D object, the modifying of the data to cause an erosion or growth of the surface of the 3D object.

15. The method of claim 14, wherein applying the map during the build operation comprises applying the map on a build material layer-by-layer basis.
